(19) United States
(12) Patent Application Publication
(10) Pub. No.: US 2019/0256001 A1
(43) Pub. Date: Aug. 22, 2019

(54) Mobile Phone Accessible Motorcycle Mirror

(71) Applicant: Jonathan Michael Weston, Studio City, CA (US)

(72) Inventor: Jonathan Michael Weston, Studio City, CA (US)

(21) Appl. No.: 16/281,366

(22) Filed: Feb. 21, 2019

Related U.S. Application Data
(60) Provisional application No. 62/633,708, filed on Feb. 22, 2018.

(51) Int. Cl. B60R 1/12; H02J 7/00

(52) U.S. Cl. CPC B60R 1/12; B60R 2001/1292; H02J 7/0044

(57) ABSTRACT

A mobile phone accessible motorcycle mirror includes a mirror housing, a phone opening, a one-way reflective surface, a stem, and a base portion. The one-way reflective surface is perimetrically connected to a rim of the mirror housing, completing a mirror section that allows the rider to see rearward. The stem tensionably and pivotably mounts the mirror housing to the handlebar of a motorcycle through the base portion. The phone opening traverses through the mirror housing, wherein the phone opening enables a mobile phone to be slidably placed behind the one-way reflective surface. Resultantly, when the mobile phone is illuminated, the mobile phone displays a GPS application of the mobile phone through the one-way reflective surface. When the mobile phone is not illuminated, the one-way reflective surface immediately returns to a completely reflective surface and a functioning mirror.

The current application claims a priority to the U.S. Provisional Patent application Ser. No. 62/633,708 filed on Feb. 22, 2018.

### FIELD OF THE INVENTION

The present invention relates generally to a motorcycle mirror modification. More specifically, the present invention is a motorcycle mirror modification that allows users to slide and secure their mobile phone behind a one-way mirror in order to execute functionalities of the cell phone.

### BACKGROUND OF THE INVENTION

Global positioning system (GPS) application within a mobile phone is very convenient and safe apparatus to use while riding a motorcycle, because it allows the user to check the data with a small glance away from the road. Normally, the mobile phone is mounted to the motorcycle tank or the motorcycle handlebar for convenient viewing, rather than averting his/her eyes all the way down to the phone in his/her pocket. However, a mobile phone placement with respect to a motorcycle handlebar still requires the motorcyclist to move their eyesight away from the road ahead thus jeopardizing the rider's safety. When riding at higher speed, the motorcyclist likes to lay forward on the motorcycle tank for reduce wind resistance. As a result, the placement of the mobile phone with respect to the motorcycle tank becomes impractical as the mobile phone is not clearly visible to the rider.

It is an objective of the present invention to provide a mobile phone accessible motorcycle mirror to utilize the mobile phone. Due to the configuration, the present invention is able to maintain the functionality of the motorcycle mirror and the GPS application of the mobile phone to the motorcyclist. Since the motorcyclists are comfortable looking at the motorcycle mirror while riding, the present invention does not jeopardize the rider's safety. The placement of the mobile phone allows the user to still see the GPS clearly when sitting down or laying forward. The present invention is also much safer because it allows users to keep their eyes within centimeters of the road ahead that he/she must be watching, in order to check in with the GPS application. More specifically, the present invention allows users to slide and secure their mobile phones behind a one-way see through mirror in order to utilize the GPS application as the mobile phone is conveniently and directly placed in front of the user's face during the motorcycle ride. The present invention saves users from getting lost, which can be not only frustrating, but also dangerous because of the compromising places on the road where the user would have to pull over to get his/her phone out of his/her pocket to use the GPS, and the subsequent overheating that can occur from being still for too long with a running motorcycle engine.

### BRIEF DESCRIPTION OF THE DRAWINGS

FIG. 1 is a perspective view of the present invention.

FIG. 2 is a perspective view of the present invention without the one-way reflective surface.

FIG. 3 is a perspective view of the present invention without the one-way reflective surface and the cap, showing the section that a detailed view is taken shown in FIG. 4.

FIG. 4 is a detailed view of the present invention taken about circle A.

FIG. 5 is a side view of the present invention, showing the camera opening and the protective glass.

FIG. 6 is a side view of the present invention, showing the damping layer, showing the plane upon which a cross sectional view is taken shown in FIG. 7.

FIG. 7 is a cross section view of the present invention taken along line A-A of FIG. 6, wherein the dash line illustrates the torsion spring.

FIG. 8 is a basic schematic diagram showing the electrical connections of the present invention.

FIG. 9 is a perspective view of the preferred track of the present invention.

FIG. 10 is a side view of the preferred track of the present invention.

### DETAIL DESCRIPTIONS OF THE INVENTION

All illustrations of the drawings are for the purpose of describing selected versions of the present invention and are not intended to limit the scope of the present invention.

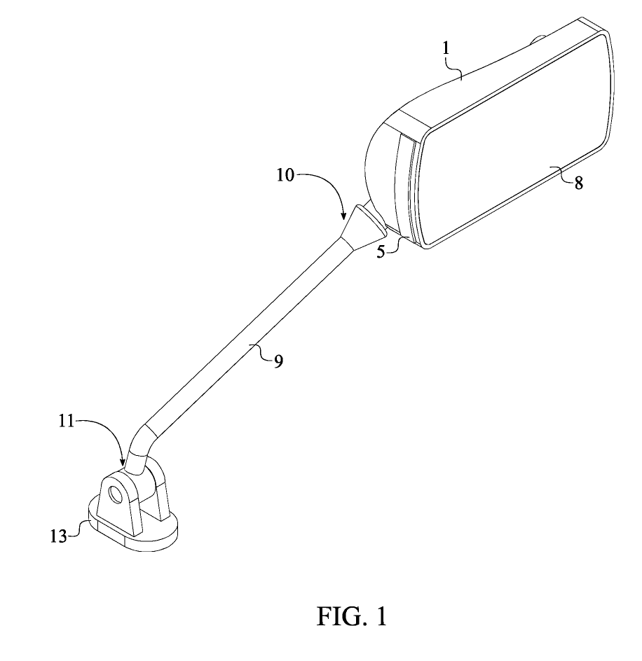

The present invention is a mobile phone accessible motorcycle mirror that enables the motorcyclist to execute software applications of a mobile phone by placing the mobile phone within the present invention. The primary software application that is executed through the present invention is global positioning system (GPS) applications of the mobile phone; however, the present invention can also execute video applications, camera applications, any other motorcycle ride related applications that are installed within the mobile phone. More specifically, the present invention functions as a normal motorcycle mirror, unless the mobile phone is illuminated within the present invention. When the mobile phone is illuminated, the mobile phone becomes visible behind a one-way reflective surface 8 of the present invention. When the mobile phone is not illuminated, the one-way reflective surface 8 immediately returns to a completely reflective surface and a functioning mirror. The present invention comprises a mirror housing 1, a phone opening 4, a stem 9, a base portion 13, and the one-way reflective surface 8 as shown in FIG. 1-3.

In reference to the general configuration of the present invention, the one-way reflective surface 8 is perimetrically connected to a rim 2 of the mirror housing 1 thus completing the mirror portion of the present invention that allows the rider to see rearward. A distal end 10 of the stem 9 is pivotably connected to the mirror housing 1, and a proximal end 11 of the stem 9 is tensionably connected to the base portion 13. As a result, the stem 9 is able to complete a support-stand for the present invention that mounts the mirror portion to the handlebar of the motorcycle. The phone opening 4 traverses through the mirror housing 1 thus enabling the motorcyclist to slide and place the mobile phone behind the one-way reflective surface 8.

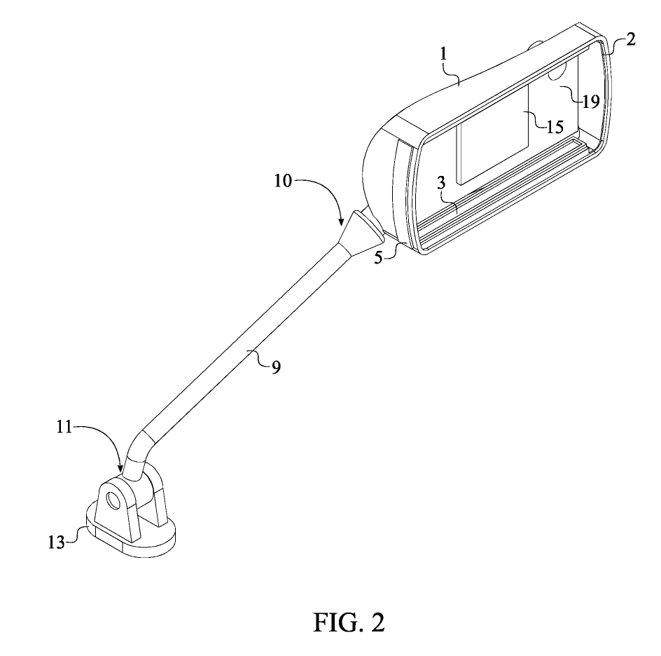

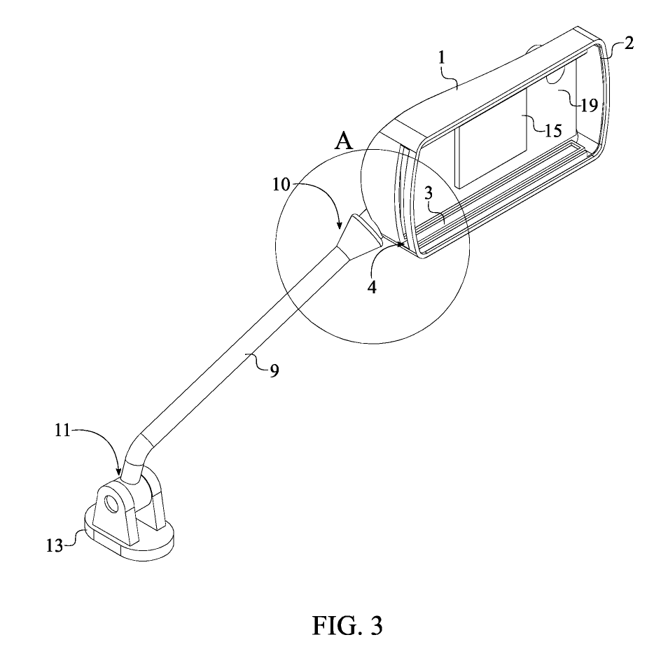

The mirror housing 1 is an enclosure and functions as the base structure for the present invention. More specifically, the mirror housing 1 protects the one-way reflective surface 8 and retains the mobile phone behind the one-way reflective surface 8. In reference to FIG. 2-3, the mirror housing 1 functions as a backing member for the one-way reflective surface 8 as the rim 2 of the mirror housing 1 secures the one-way reflective surface 8. Due to the cup-shaped form of the mirror housing 1, the connection between the mirror housing 1 and the one-way reflective surface 8 delineates an empty space that allows the mobile phone to be inserted through the phone opening 4.

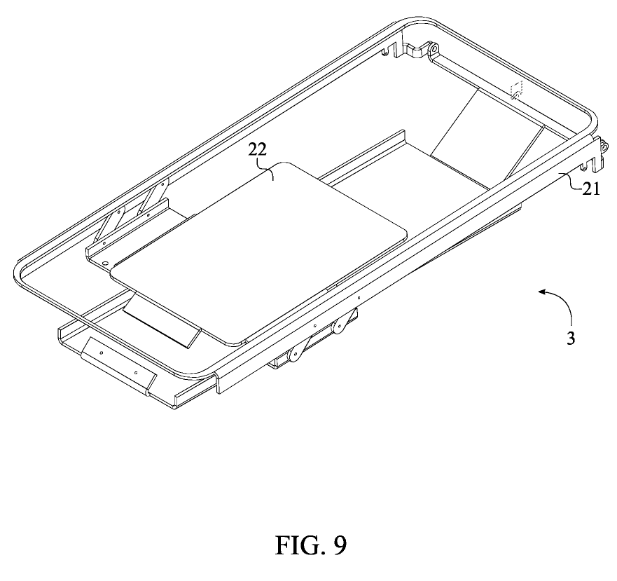

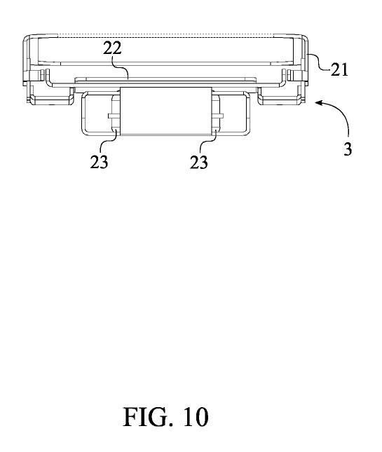

In reference to FIG. 2-3, the present invention further comprises a track 3. The track 3 is positioned within the mirror housing 1 and the one-way reflective surface 8 so that the track 3 is able to secure the mobile phone once the mobile phone is inserted through the phone opening 4. More specifically, the track 3 is connected to the mirror housing 1 and aligned with the phone opening 4 so that the mobile phone can be easily engaged and secured to the track 3. Additionally, the track 3 can also securely engage with a plurality of external cartridges that fits around different types and sizes of mobile phones. Due to the utilization of the plurality of external cartridges, the present invention is widely accessible with multiple mobile phones, not limiting to a specific type or brand of mobile phone. A preferred embodiment of the track 3 comprises a support structure 21, a hinged platform 22, at least one spring 23 as shown in FIG. 9-10 More specifically, the support structure 21 is perimetrically connected to the mirror housing 1 and functions as the base structure. The hinged platform 22 is terminally connected to the support structure 21 as the connection between the hinged platform 22 and the support structure 21 is positioned opposite of the phone opening 4. The spring 23 is terminally mounted to the support structure 21 and positioned below the hinged platform 22. As a result, a free end of the spring 23 is able to push the hinged platform 22 towards the one-way reflective surface 8. When the mobile phone is inserted into the track 3 through the phone opening 4, the mobile phone pushes down on the hinged platform 22 thus compressing the spring 23. Once the mobile phone is fully inserted into the mirror housing 1, the hinged platform 22 centrally positions the mobile phone within the track 3 as the spring 23 ensures that the mobile phone is positioned flush and pushed against to the one-way reflective surface 8. As a result, the track 3 is able to eliminate accidental slippage of the mobile phone within the mirror housing 1.

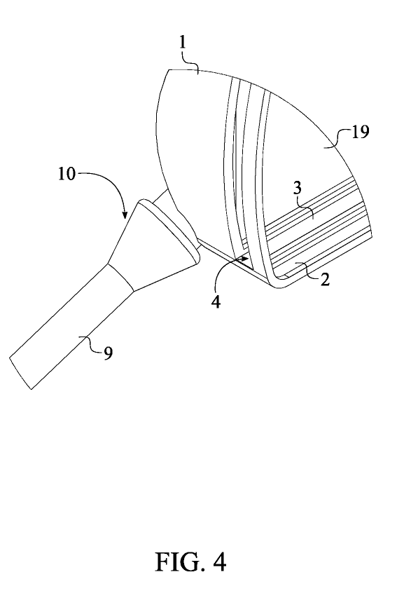

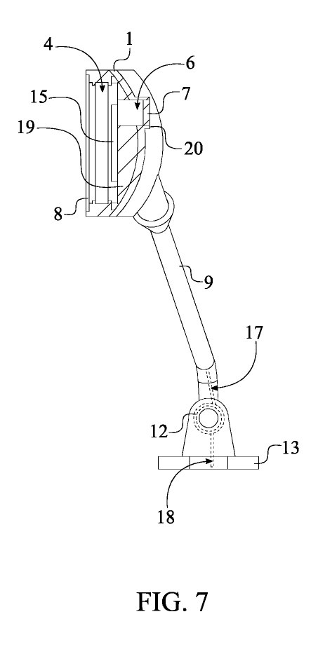

In reference to FIG. 4 and FIG. 7, the present invention further comprises a damping layer 19 to reduce the vibration of the mobile phone within the mirror housing 1. More specifically, the damping layer 19 is superimposed into the mirror housing 1 and completely covers the inside surface of the mirror housing 1. In other words, the damping layer 19 is positioned in between the mirror housing 1 and the one-way reflective surface 8. The damping layer 19 functions as a shock absorbing layer to absorb the motorcycle engine vibration and the ride vibration that may act upon the present invention. As a result, the mobile phone is able to clearly display the GPS applications to the motorcyclist, clearly capture pictures through the camera applications, and clearly capture videos through the video applications. Additionally, the reduction of vibration within the present invention eliminates accidental dislodging and misalignment of the mobile phone.

In reference to FIG. 2, the present invention further comprises a cap 5 to seal the phone opening 4 from outside elements so that the present invention can function as a water tight unit, to ensure safety in inclement weather and watersports. More specifically, the cap 5 is perimetrically positioned around the phone opening 4 and hermetically attached to the mirror housing 1. In other words, the cap 5 functions as a plug for the phone opening 4 so that the mobile phone can be protected within the mirror housing 1. For example, the cap 5 is first detached from the phone opening 4 so that the motorcyclist is able to insert the mobile phone into the track 3. Once the mobile phone is inserted into the track 3, the cap 5 is reattached into the phone opening 4 securing the mobile phone inside.

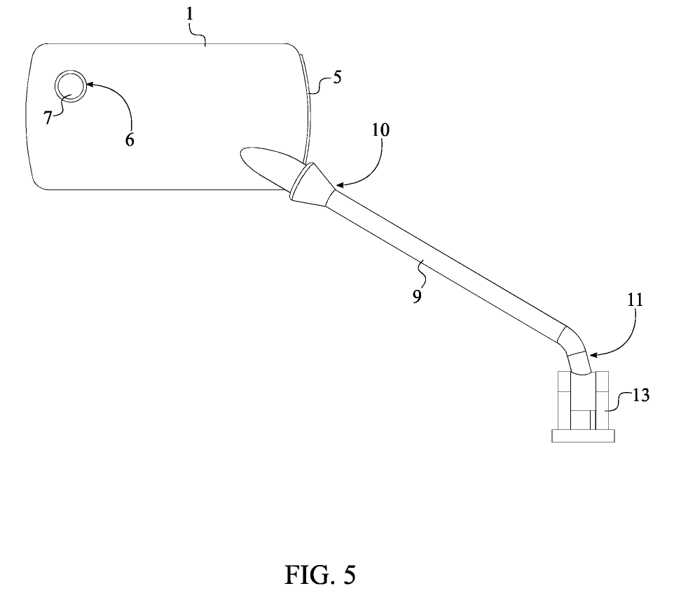

In reference to the FIG. 5 and FIG. 7, the present invention further comprises a camera opening 6 and a protective glass 7 thus permitting a main camera of the mobile phone to be accessed through the present invention. More specifically, the camera opening 6 traverses through the mirror housing 1 and oppositely positioned of the one-way reflective surface 8. The protective glass 7 is perimetrically connected within an edge 20 of the camera opening 6 in order to protect the main camera of the mobile phone from outside elements that may come into the contact. When the mobile phone is inserted into the mirror housing 1 and engaged with the track 3, the main camera of the mobile phone concentrically aligns with the camera opening 6 thus maintaining the full functionalities of the main camera of the mobile phone. As a result, the motorcyclist is able to capture audio-visual recordings or pictures of the motorcycle ride by utilizing the main camera of the mobile phone and the camera opening 6. Additionally, a front camera of the mobile phone can be accessed through the one-way reflective surface 8 to capture audio-visual recordings or pictures of the motorcyclist during the motorcycle ride.

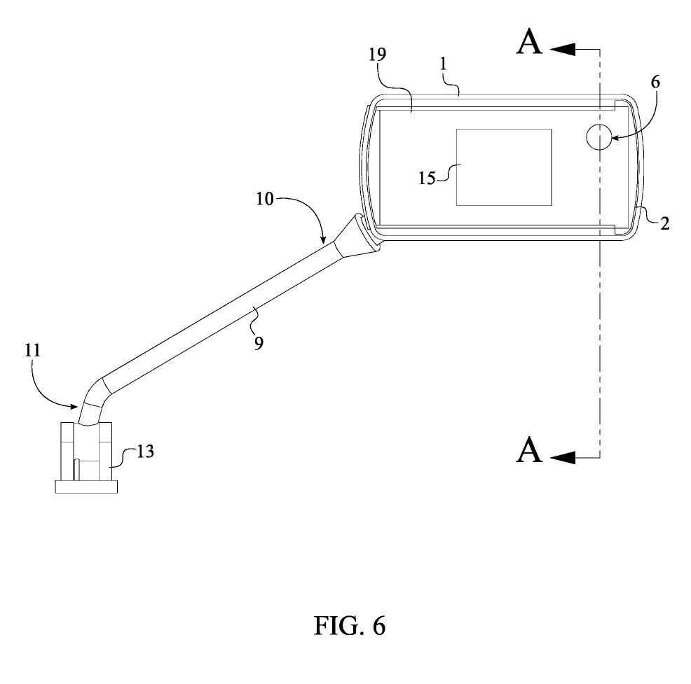

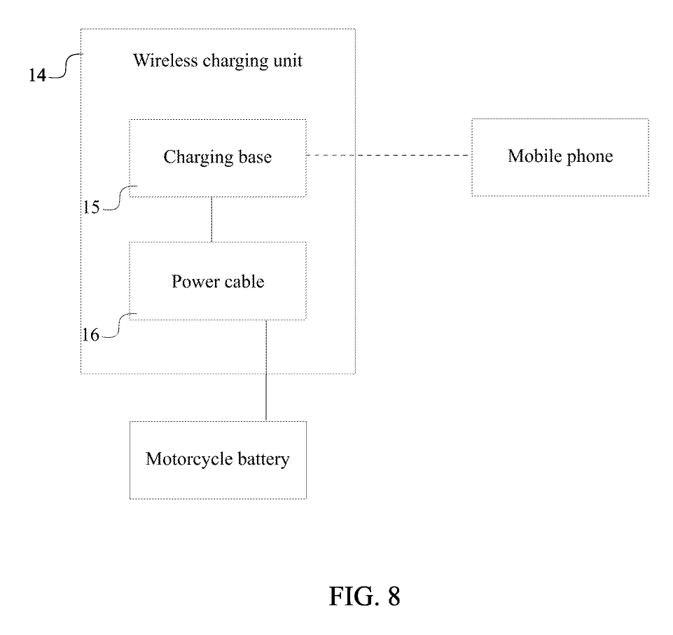

The reference to FIG. 6 and FIG. 8, the present invention further comprises a wireless charging unit 14 that is communicably coupled with a battery of the mobile phone to wirelessly charge the mobile phone. More specifically, a charging base 15 of the wireless charging unit 14 is positioned in between the mirror housing 1 and the one-way reflective surface 8. As a result, the charging base 15 is positioned behind the mobile phone and adjacent to the battery of the mobile phone. A power cable 16 of the wireless charging unit 14 is positioned within the stem 9 and the base portion 13 as the charging base 15 and the power cable 16 are electrically connected to each other. As a result, the power cable 16 is able to electrically connect a motorcycle battery to the charging base 15 so that the wireless charging unit 14 can wirelessly charges the battery of the mobile phone.

The stem 9, which functions as the supporting-stand of the mirror housing 1, further comprises a torsion spring 12. In reference to FIG. 1, a first section 17 of the torsion spring 12 is connected within the proximal end 11 of the stem 9. A second section 18 of the torsion spring 12 is outwardly extended from the proximal end 11 of the stem 9 and connected within the base portion 13. The torsion spring 12 functions as an easy collapsing mechanism within the present invention to protect the mirror housing 1 and the mobile phone. More specifically, when a back surface of the mirror housing 1 comes into the contact with an obstruction, the mirror housing 1 and the stem 9 bent towards the motorcyclist about the base portion 13 due to the pilotable connection. However, due to the positioning and structural integrity of the torsion spring 12, the mirror housing 1 and the stem 9 return the upright positioning once the obstruction is cleared. As a result, the present invention and the mobile phone can be protected from accidental impact that can easy occurs during a motorcycle ride. Additionally, the motorcyclist doesn't have to stop the motorcycle and manually push back the mirror housing 1 and the stem 9 back into the upright position as the torsion spring 12 automatically pushes back the mirror housing 1 and the stem 9.

Once the mobile phone is placed within the present invention, the mobile phone can be operated through a wireless controller. More specifically, the wireless controller is mounted to the handlebar of the motorcycle so that the motorcyclist can easily access the wireless controller during the motorcycle ride. The wireless controller is communicably coupled with the mobile phone over a short distance data exchanging network. As a result, the motorcyclist can selectively execute GPS applications, video applications, camera applications, and any other motorcycle ride related applications that are installed within the mobile phone through the wireless controller. Due to the configuration, the present invention is able to present the functionality of the motorcycle mirror and the GPS applications of the mobile phone to the motorcyclist. Since the motorcyclists are comfortable looking at the motorcycle mirror while riding, the present invention does not jeopardize the rider's safety. The placement of the mobile phone allows the motorcyclists to still see the GPS applications clearly when sitting down or laying forward. The present invention is also much safer because it allows motorcyclists to keep their eyes within centimeters of the road ahead that he/she must be watching, in order to check in with the GPS applications.

Although the invention has been explained in relation to its preferred embodiment, it is to be understood that many other possible modifications and variations can be made without departing from the spirit and scope of the invention as hereinafter claimed.

What is claimed is:

1. A mobile phone accessible motorcycle mirror comprises:
a mirror housing;
a phone opening;
a one-way reflective surface;
a stem;
a base portion;
the one-way reflective surface being perimetrically connected to a rim of the mirror housing;
a distal end of the stem being pivotably connected to the mirror housing;
a proximal end of the stem being tensionably connected to the base portion; and
the phone opening traversing through the mirror housing, wherein the phone opening enables a mobile phone to be slidably placed and locked behind the one-way reflective surface.

2. The mobile phone accessible motorcycle mirror as claimed in claim 1 comprises:
the stem further comprises a torsion spring;
a first section of the torsion spring being connected within the proximal end of the stem;
a second section of the torsion spring being outwardly extended from the proximal end of the stem; and
the second section of the torsion spring being connected within the base portion.

3. The mobile phone accessible motorcycle mirror as claimed in claim 1 comprises:
a track;
the track being positioned within the mirror housing and the one-way reflective surface;
the track being connected to the mirror housing; and
the track being aligned with the phone opening.

4. The mobile phone accessible motorcycle mirror as claimed in claim 1 comprises:
a damping layer;
the damping layer being superimposed into the mirror housing; and
the damping layer being positioned in between the mirror housing and the one-way reflective surface.

5. The mobile phone accessible motorcycle mirror as claimed in claim 1 comprises:
a cap;
the cap being perimetrically positioned around the phone opening; and
the cap being hermetically attached to the mirror housing.

6. The mobile phone accessible motorcycle mirror as claimed in claim 1 comprises:
a camera opening;
the camera opening traversing through the mirror housing; and
the camera opening being oppositely positioned of the one-way reflective surface, wherein the camera opening aligns with a built-in camera of the mobile phone.

7. The mobile phone accessible motorcycle mirror as claimed in claim 6 comprises:
a protective glass; and
the protective glass being perimetrically connected around an edge of the camera opening.

8. The mobile phone accessible motorcycle mirror as claimed in claim 1 comprises:
a wireless charging unit;
a charging base of the wireless charging unit being positioned within the mirror housing and the one-way reflective surface;
a power cable of the wireless charging unit being positioned within the stem and the base portion; and
the charging base and the power cable being electrically connected to each other, wherein the power cable electrically connected to a motorcycle battery to power the charging unit.

9. A mobile phone accessible motorcycle mirror comprises:
a mirror housing;
a phone opening;
a one-way reflective surface;
a stem;
a base portion;
a camera opening;
the one-way reflective surface being perimetrically connected to a rim of the mirror housing;
the camera opening traversing through the mirror housing;
the camera opening being oppositely positioned of the one-way reflective surface, wherein the camera opening aligns with a built-in camera of a mobile phone;
a distal end of the stem being pivotably connected to the mirror housing;
a proximal end of the stem being tensionably connected to the base portion; and
the phone opening traversing through the mirror housing, wherein the phone opening enables the mobile phone to be slidably placed and locked behind the one-way reflective surface.

10. The mobile phone accessible motorcycle mirror as claimed in claim 9 comprises:
the stem further comprises a torsion spring;
a first section of the torsion spring being connected within the proximal end of the stem;
a second section of the torsion spring being outwardly extended from the proximal end of the stem; and
the second section of the torsion spring being connected within the base portion.

11. The mobile phone accessible motorcycle mirror as claimed in claim 9 comprises:
a track;
the track being positioned within the mirror housing and the one-way reflective surface;
the track being connected to the mirror housing; and
the track being aligned with the phone opening.

12. The mobile phone accessible motorcycle mirror as claimed in claim 9 comprises:
a damping layer;
the damping layer being superimposed into the mirror housing; and
the damping layer being positioned in between the mirror housing and the one-way reflective surface.

13. The mobile phone accessible motorcycle mirror as claimed in claim 9 comprises:
a cap;
the cap being perimetrically positioned around the phone opening; and
the cap being hermetically attached to the mirror housing.

14. The mobile phone accessible motorcycle mirror as claimed in claim 9 comprises:
a protective glass; and
the protective glass being perimetrically connected around an edge of the camera opening.

15. The mobile phone accessible motorcycle mirror as claimed in claim 9 comprises:
a wireless charging unit;
a charging base of the wireless charging unit being positioned within the mirror housing and the one-way reflective surface;
a power cable of the wireless charging unit being positioned within the stem and the base portion; and
the charging base and the power cable being electrically connected to each other, wherein the power cable electrically connected to a motorcycle battery to power the charging unit.
